(19) United States
(12) Patent Application Publication
(10) Pub. No.: US 2013/0092253 A1
(43) Pub. Date: Apr. 18, 2013

(54) DEVICE FOR DISTRIBUTION OF A PLASTIC MELT

(71) Applicant: MAAG PUMP SYSTEMS GMBH, Grossostheim (DE)

(72) Inventor: Markus Steinmann, Zurich (CH)

(73) Assignee: MAAG PUMP SYSTEMS GMBH, Grossostheim (DE)

(21) Appl. No.: 13/651,009

(22) Filed: Oct. 12, 2012

(30) Foreign Application Priority Data
Oct. 12, 2011 (DE) 202011106715.0

(51) Int. Cl. F16L 3/00

(52) U.S. Cl. 137/343

(57) ABSTRACT

A device for distribution of a plastic melt, wherein the device can have a main housing body. The main housing body can have at least one inlet channel and at least one outlet channel for the plastic melt. At least one receiving opening can extend between the at least one inlet channel and at least one outlet channel. A movable distributor body can be disposed within the receiving opening. The movable distributor body can have sealing surfaces for sealing with the receiving opening. The movable distributor body can be guided by the sealing surfaces.

### CROSS REFERENCE TO RELATED APPLICATIONS

The present patent application claims priority to and the benefit of co-pending DE Application No. 20 2011 106 715.0, which was filed Oct. 12, 2011, entitled “DEVICE FOR DISTRIBUTION OF A PLASTIC MELT.” This reference is incorporated in its entirety herein.

### FIELD

The present embodiments generally relate to a device for distribution of a plastic melt, such as a thermoplastic melt.

### BACKGROUND

A need exists for a device for distribution of a plastic melt that provides a simple design and a reliable operation.

A further need exists for a device for distribution of a plastic melt that is safe against seizure caused by solidified plastic melt and ready for operation at all times.

The present embodiments meet these needs.

### BRIEF DESCRIPTION OF THE DRAWINGS

The detailed description will be better understood in conjunction with the accompanying drawings as follows:

FIG. 1 depicts a schematic representation of a device for distribution of a plastic melt in a pass-through position.

FIG. 2 depicts a schematic representation of the device for distribution of a plastic melt from FIG. 1 in a start-up position.

FIG. 3 depicts a cross-sectional view along line A-A of FIG. 1.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a device for distribution of a plastic melt, such as a thermoplastic melt.

The device for distribution of a plastic melt can include a main housing body. The main housing body can have at least one inlet channel and at least one outlet channel for the plastic melt.

A receiving opening can extend between the at least one inlet channel and the at least one outlet channel. The receiving opening can receive at least one movable distributor body. The movable distributor body can be located in the receiving opening.

The movable distributor body can be penetrated by at least one distributor channel. The plastic melt can pass through the at least one distributor channel. At least one of the distributor channels establishes fluid communication between the inlet channel and the outlet channel when the distributor channel is in a pass-through position. There can be fluid communication between the inlet channel and at least one of the distributor channels, when the distributor body is in a start-up position. The distributor channel can have a discharge opening for the plastic melt.

The movable distributor body can have one or more sealing surfaces arranged around the at least one distributor channel. The sealing surface can exclusively provide a seal between the movable distributor body and the housing in the region of the receiving opening channels. Movement of the movable distributor body in the receiving opening is guided at least by the sealing surfaces. The use of the sealing surfaces to provide the sealing contact with the main housing in the region of the receiving channel reduces the contact area of the sealing surfaces. Therefore, sealing of the movable distributor body against the main housing body is provided exclusively in the region of around the at least one distributor channel. Consequently, there is no large-area of contact between the body of the distributor and the receiving opening. Instead, there is only a local sealing surface around each of the distributor channels.

Guiding bars can be between the movable distributor body and the receiving opening. The guiding bars can guide the movement of the distributor body in the receiving opening. The guiding bars can be arranged on the distributor body. The provided guiding bars can ensure effective support of the distributor body in the receiving opening with respect to the main housing body without unnecessarily increasing the contact area.

A radial clearance averaging about 1 millimeter can be formed between the distributor body and the receiving opening with the exception of the sealing surfaces, guiding bars, or both. Jam-free guiding, combined with simple and effective maintenance of the clearance of the movable distributor body in the receiving opening with respect to the main housing body can be achieved with a clearance averaging about 1 millimeter without resulting in excessive dead spaces.

There can be a continuously stepless transition between the sealing surfaces as well as the guiding bars and the other regions of the movable distributor body. The continuously stepless design, which can be accomplished, for example, by rounding of the transitions, can make it possible to prevent the sticking of plastic melt in the regions due to the absence of distinct edges in said locations, which can effectively prevent the sticking of plastic melt.

The sealing surfaces can have a minimum width of about 20 millimeters.

The movable distributor body can be axially displaceable between the start-up position and the pass-through position. Displacement can be advantageously effected by a hydraulic device. In addition to axial displacement of the movable distributor body, it is also conceivable, given a suitable configuration of the at least one inlet channel and at least one outlet channel, to make the movable distributor body rotatable in the main housing body between the start-up position and the pass-through position, which can result in a compact construction.

The form of the receiving opening and of the distributor body therein can be cylindrical. If there is relative movement by rotation, a conical or truncated-conical form can also be conceivable, in which case the receiving opening can have a circular cross-section. Such designs can be easy to manufacture and particularly fluidically efficient for the flow of plastic melt, this allowing reliable operation of the device for distribution of a plastic melt.

The elements of the device for distribution of a plastic melt can be of secular or generally circular cross-section. However, it is also conceivable for the cylindrical or polygonal cross-section, i.e., by elements of polygonal form, in which case, the edge regions can be of continuously stepless design, such as a rounded design. Ellipsoidal cross-sections or cross-sections including circularly segmented forms can be likewise conceivable.

Plastic melt can be a polypropylene, polyethylene, high-pressure polypropylene, low-pressure polyethylene, linear low-pressure polyethylene, polystyrene, polyamide, acrylonitrile butadiene styrene (ABS), polyester, polyoxymethylene (POM), polyacrylate, polymethyl methacrylate (PMMA), polyvinyl chloride melt, or the like.

Turning now to the Figures, FIG. 1 depicts a schematic representation of a device for distribution of a plastic melt in a pass-through position.

The device for distribution of a plastic melt can include a main housing body 1. The main housing body 1 can have a cross-section and can extend in the longitudinal direction. The main housing body 1 can have at least one inlet channel 2 and at least one outlet channel 3 for the plastic melt.

In the main housing body 1, at least one receiving opening 4 can extend between the at least one inlet channel 2 and the at least one outlet channel 3.

At least one movable distributor body 5 can be disposed in receiving opening 4. The at least one movable distributor body 5 can be penetrated by one or more distributor channels 6 and 7, which can receive the plastic melt depending on the position.

The movable distributor body 5 can be axially displaceable in the receiving opening 4 with respect to the main housing body 1 when the distributor body 5 is in a pass-through position. The movable distributor body 5 can establish fluid communication between the inlet channel 2 and the outlet channel 3 through the intermediary of at least one of the distributor channels, such as the first distributor channel 6.

There can be one or more sealing surfaces 9, 10, and 11 between the movable distributor body 5 and the receiving opening 4.

At least one of the distributor channels, such as the second distributor channel 7, can have a discharge opening 8.

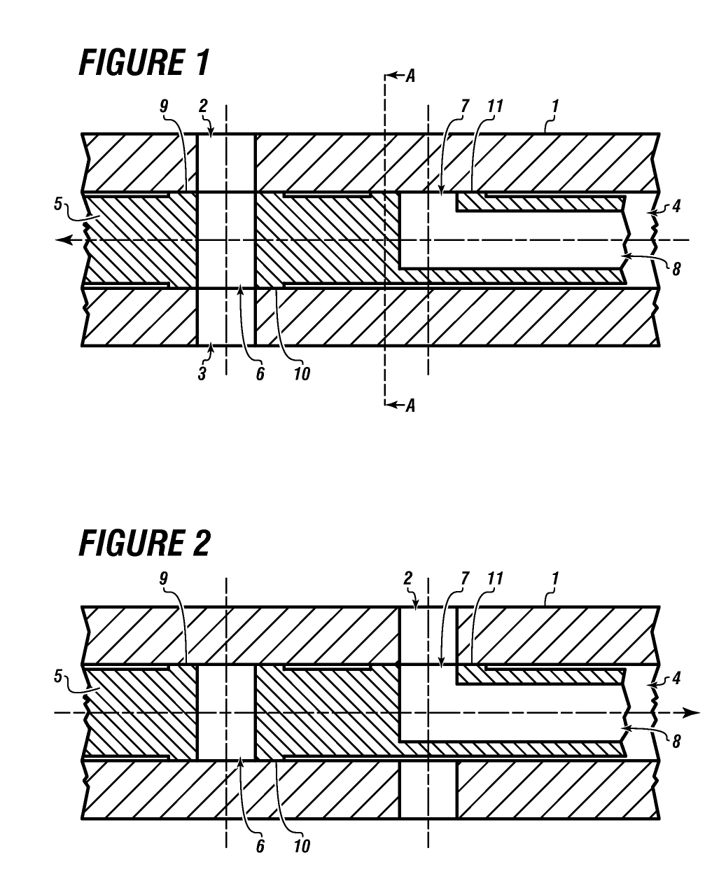

FIG. 2 depicts a schematic representation of the device for distribution of a plastic melt from FIG. 1 in a start-up position.

Fluid communication can be established between the inlet channel 2 and at least one of the distributor channels, such as the second distributor channel 7, in the movable distributor body 5 when the movable distributor body 5 is in the start-up position. The second distributor channel 7 can have the discharge opening 8 for the plastic melt.

As presented in both FIG. 1 and FIG. 2, the distributor channel can have the discharge opening 8 facing towards the end face of the movable distributor body 5.

Alternatively, the distributor channel 7 with the discharge opening 8 can be in fluid communication with a discharge opening in the main housing body 1. In this embodiment, in the start-up position, there can be fluid communication between the distributor channel 7 and the discharge opening 8 in the main housing body 1. The discharge opening 8 and the distributor channel 7 can have corresponding sealing surfaces of the movable distributor body 5 with respect to the main housing body 1. Although not presented in FIG. 1 and FIG. 2, this possibility is readily available to the person with skill in the art with the aid of this disclosure.

The possibility of an axial movement of the movable distributor body 5 in the receiving opening 4 is indicated by an arrow in FIG. 1 and FIG. 2.

In addition to the axial movement, it is also conceivable for the transition between the start-up position and the pass-through position to be accomplished not by axial movement of the movable distributor body 5 in the main housing body 1, and therefor in the receiving opening 4 of the main housing body 1, but by appropriate rotation of the movable distributor body 5.

The movable distributor body 5 can be sealingly in contact with the main housing body 1 in the region of the receiving opening 4 exclusively through the intermediary of the sealing surfaces 9, 10, and 11 arranged around the distributor channels 6 and 7. The movable distributor body 5 can be guided in the receiving opening 4 through the intermediary of said sealing surfaces 9, 10, and 11.

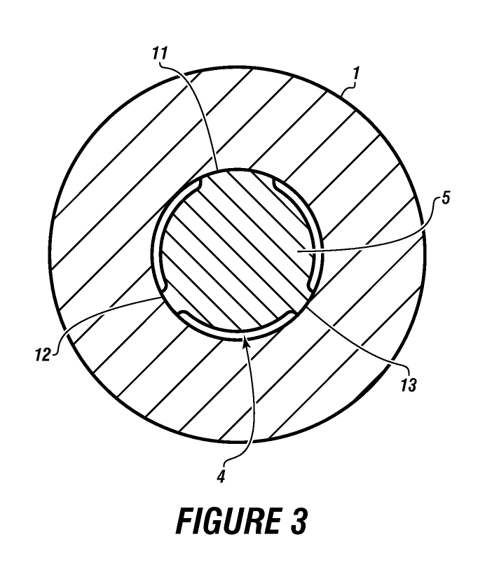

FIG. 3 depicts a cross-sectional view along line A-A of FIG. 1.

There can be additional guiding bars 12 and 13 located between the movable distributor body 5 and the receiving opening 4. The additional guiding bars 12 and 13 can guide the movement of the movable distributor body 5 in the receiving opening 4. The additional guiding bars 12 and 13 can be arranged on the movable distributor body 5.

In an embodiment, the additional guiding bars 12 and 13 can be on the main housing body 1 and protrude into the receiving opening 4, thereby guiding the movable distributor body 5.

There can be a continuously stepless transition between the sealing surfaces, such as sealing surface 11; the additional guiding bars 12 and 13; and other regions of the movable distributor body 5. The transition can be a circular segment, which avoids sharp edges.

As is further apparent from the representation in FIG. 3, the contact area of the movable distributor body 5 with respect to the main housing body 1 is drastically reduced, with the result that, a large-area dissipation of heat, and thus a large-area sticking of plastic melt between the distributor body and the main housing body, can thus be reliably prevented.

The device for distribution of a plastic melt, which is of simple design and without constructional complexity, can provide an operationally reliable distribution device that is simple and quick to operate.

While these embodiments have been described with emphasis on the embodiments, it should be understood that within the scope of the appended claims, the embodiments might be practiced other than as specifically described herein.

What is claimed is:

1. A device for distribution of a plastic melt, the device comprising:
a. a main housing body comprising:
(i) at least one inlet channel;
(ii) at least one outlet channel for the plastic melt; and
(iii) at least one receiving opening extending between the at least one inlet channel and the at least one outlet channel;
b. a movable distributor body disposed within the at least one receiving opening; and
c. at least one distributor channel penetrating the movable distributor body, wherein the at least one distributor channel has a discharge opening for the plastic melt, and wherein with the movable distributor body in a pass-through position, at least one of the distributor channels establishes a fluid connection between the inlet channel and the outlet channel, and wherein with the movable distributor body in a start-up position, there is a fluid connection between the inlet channel and the at least one of the distributor channels, and wherein the movable distributor body is sealingly in contact with the main housing body in the region of the receiving opening exclusively through the intermediary of sealing surfaces arranged around the distributor channels, wherein the movement of the movable distributor body in the receiving opening is guided at least by the sealing surfaces.

2. The device of claim 1, wherein the movement of the movable distributor body in the receiving opening is guided exclusively by the sealing surfaces.

3. The device of claim 1, further comprising guiding bars between the movable distributor body and the receiving opening, wherein the guiding bars additionally guide the movement of the movable distributor body in the receiving opening, wherein the guiding bars are arranged on the movable distributor body.

4. The device of claim 3, further comprising a radial clearance averaging 1 millimeter between the movable distributor body and the receiving opening, with the exception of the sealing surfaces or guiding bars.

5. The device of claim 4, wherein there is a continuously stepless transition between the sealing surfaces, the guiding bars, and the other regions of the distribution body.

6. The device of claim 3, wherein there is a continuously stepless transition between the sealing surfaces, the guiding bars, and the other regions of the distribution body.

7. The device of claim 1, wherein the sealing surfaces have a minimum width of 20 millimeters.

8. The device of claim 2, wherein the sealing surfaces have a minimum width of 20 millimeters.

9. The device of claim 3, wherein the sealing surfaces have a minimum width of 20 millimeters.

10. The device of claim 4, wherein the sealing surfaces have a minimum width of 20 millimeters.

11. The device of claim 1, wherein the movable distributor body is axially displaceable between the start-up position and the pass-through position.

12. The device of claim 2, wherein the movable distributor body is axially displaceable between the start-up position and the pass-through position.

13. The device of claim 3, wherein the movable distributor body is axially displaceable between the start-up position and the pass-through position.

14. The device of claim 4, wherein the movable distributor body is axially displaceable between the start-up position and the pass-through position.

15. The device of claim 5, wherein the movable distributor body is axially displaceable between the start-up position and the pass-through position.
